(19) United States
(12) Patent Application Publication
(10) Pub. No.: US 2004/0235528 A1
(43) Pub. Date: Nov. 25, 2004

(54) Overlapped subarray antenna feed network for wireless communication system phased array antenna

(76) Inventor: Ilya A. Korisch, New Brunswick, NJ (US)

Correspondence Address: GREENBERG TRAURIG, LLP, 885 Third Avenue, New York, NY, 10022, US

(21) Appl. No.: 10/442,778

(22) Filed: May 21, 2003

(51) Int. Cl. H04B 1/38

(52) U.S. Cl. 455/562.1; 455/561

(57) ABSTRACT

An antenna phased array comprising a two-input four-output beam forming network where each of the four outputs is coupled to one of four antennas. The antennas generate beams of signals from signals applied to the inputs of the beam forming network. The antennas form two sub-arrays of antennas each comprising three antennas. The beam forming network is designed such that the beams generated by each of the sub-arrays form aggregate beams having desired beam widths. Adjacent antennas are spaced a certain distance apart such that beam steering can be performed by combining the two aggregate beams.

### BACKGROUND OF THE INVENTION

1. Field of the Invention

The present invention relates to antenna systems for wireless communication systems.

2. Description of the Related Art

Antenna systems are key components of a wireless communication system. Antenna systems are typically part of system equipment located at a base station of a cell that is part of a wireless communication system. The cell is a defined geographic area that is served by the base station equipment. In many instances the cell is divided into sectors that are covered by one or more antennas; that is, each sector of a cell has one or more antennas that radiate beams of signals that substantially cover the entire sector. In many communication systems a first antenna is used to broadcast communication signals to all users located in the sector being covered. Also, the first antenna is often used in combination with at least a second antenna to perform beam steering for conveying (i.e., transmit and/or receive) communication signals carrying traffic information between users of the system. Beam steering is achieved by the manipulation of the phase and amplitude of the signals forming a beam so that the beam or a combined beam is directed at a desired direction and the beam also has a certain beam width. Beam steering is performed with the combination of two or more beams. Referring to FIG. 1, there is shown a top view of a beam being generated by an antenna. A longitudinal axis extended from the antenna to the peak value (point of peak power) of the beam is known as the bore sight. Line segments extending from the antenna to the 3 dB points (points at which the power is 50% of the peak power) form an angle, θ, which is defined as the beam width.

As wireless communication systems evolve, the design parameters for such systems change accordingly. Communication systems, which use one antenna to broadcast signals throughout a sector of a cell and the combination of the one antenna with another antenna to radiate a beam in a specific direction, often require that the beams have a particular beam width. The desired beam width of the broadcast beam and the steered beam is often very difficult to achieve because of the coupling that occurs between the two antennas. Coupling is a natural phenomenon in which the energy radiated by one antenna is scattered by a nearby antenna so that the resulting beam width is constrained to within a certain range (e.g., 90°-100°) that is extremely difficult to change. In recent systems, an exemplary beam width is 65° is often desired especially for CDMA (Code Division Multiple Access) system and UMTS (Universal Mobile Telecommunications System) systems. A 65° beam width for the broadcast beam is difficult to obtain because the coupling between the two antennas often generates beams having beam widths of about 90° that are very difficult to change. The coupling between the antennas can be substantially reduced by increasing the distance between the two antennas. However, in order to perform beam steering and in order to determine the direction of signals received by the antennas, the two antennas should be a certain distance from each other; typically that distance is approximately half a wavelength (i.e.,

$$( i . e . , \frac{1}{2} λ ) .$$

The wavelength, λ, is related to the frequency range of the signals that is being radiated by the antennas. The wavelength for purposes of judging distances between antennas is typically obtained from the average or mean of a range of frequencies being represented by the signals that are radiated by the antennas. Thus, because of the need to perform beam steering and the need to determine the direction from which signals are being received, the antennas are placed at a distance from each other that will cause coupling to occur. Therefore, it is very difficult to meet the requirements of beam widths of 65° while also meeting the requirement of the ability to perform beam steering and to be able to determine the directions from which signals are being received.

A third antenna can be added which would provide sufficient flexibility to design an aggregate beam of a desired beam width (e.g., 65°) in spite of the coupling between the antennas. Further, a third antenna would also allow beam steering to be performed and also allow the equipment to determine the direction from which signals are being received by the antennas. A third antenna presents a practical problem, however, in that an extra antenna would be required, and more importantly, an extra input cable would be needed for such an antenna. In wireless communication systems each of the antennas are mounted on a tower. Each antenna has a cable connected to it from the electronics located at the base of the tower or nearby the base of the tower. Service providers typically require minimum possible number of cables for each tower because of the relatively high cost of installment and maintenance of the cables and their associated antennas. Therefore, towers with three or more cables would substantially increase the cost of operating a wireless communication system. In sum, the addition of a third antenna is not a practical or realistic solution.

What is therefore needed is an antenna system which can generate beams or aggregate having desired beam widths and also adjacent antennas can be spaced a desired distance from each other to allow the combination of such beams to be steered and such antennas can be used to determine the angle from which signals are being received.

### SUMMARY OF THE INVENTION

The present invention provides an antenna phased array for generating beams having desired beam widths and where such beams can be combined to perform beam steering. The antenna phased array of the present invention comprises a beam forming network coupled to a plurality of antennas that generate beams of signals from signals applied to the beam forming network. The plurality of antennas form sub-arrays of antennas that generate aggregate beams formed from the generated beams where such aggregated beams have desired beam widths and such aggregated beams can be combined to perform beam steering. The plurality of antennas may be positioned such that the distance between adjacent antennas is a defined distance that allows the aggregate beams to combine with each other to allow beam steering to be performed. The steered beam is used to convey (i.e., transmit and/or receive) user information. User information is information generated by mobiles and/or users of the communication system.

In one embodiment, the antenna phased array comprises four antennas forming two overlapping sub-arrays of three antennas each of which generates an aggregate beam having a beam width of 65° where both aggregate beams can be combined to perform beam steering. A two-input, four-output beam forming network is coupled to the four antennas and the signals from which the aggregate beams are formed are applied to the two inputs of the beam forming network. Adjacent antennas of the four antennas are placed

$$\frac{1}{2}$$

wavelength apart where the wavelength is related to a range of frequency values of the input signals. Thus, when the antenna phased array is mounted on a tower of a wireless communication system, two cables can be used to apply the signals to the beam forming network portion of the antenna phased array of the present invention.

### BRIEF DESCRIPTION OF THE DRAWINGS

FIG. 1 is a top view of a beam being generated by an antenna where the beam has a beam width of θ degrees;

FIG. 2 is a block diagram of the intelligent antenna network of the present invention;

FIG. 3 is a more detailed depiction of FIG. 2.

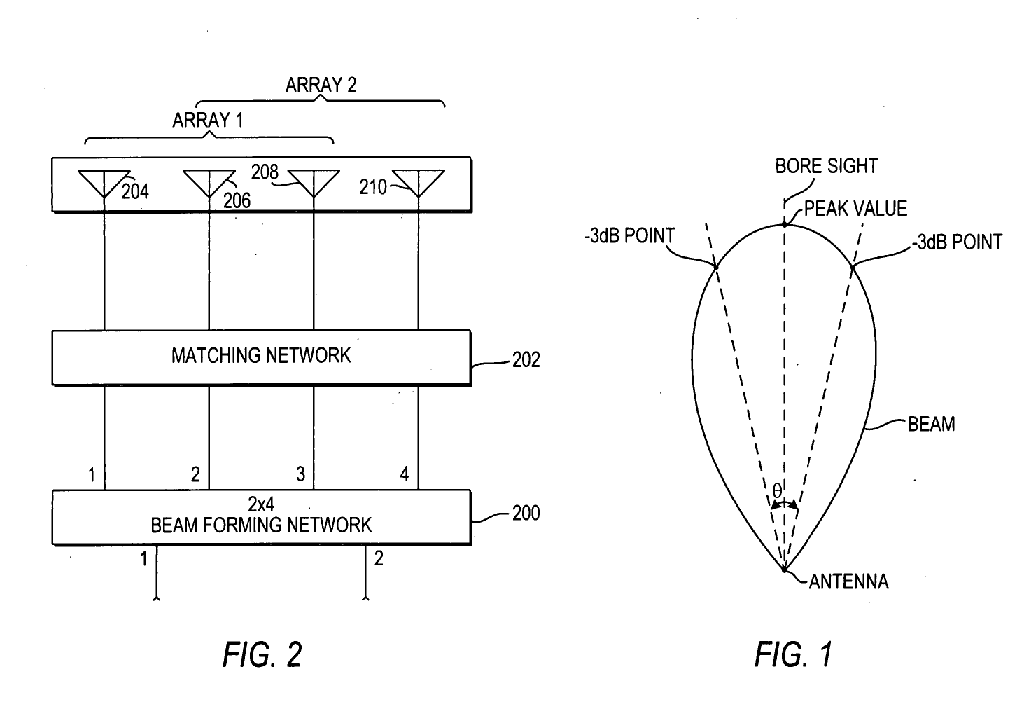

### DETAILED DESCRIPTION

The present invention provides an antenna phased array that generate beams having desired beam widths and where such beams can be combined to perform beam steering. The antenna phased array of the present invention comprises a beam forming network coupled to a plurality of antennas that generate beams of signals from signals applied to the beam forming network. The plurality of antennas form sub-arrays of antennas that generate aggregate beams formed from the generated beams where such aggregated beams have desired beam widths and such aggregated beams can be combined to perform beam steering. The plurality of antennas may be positioned such that the distance between adjacent antennas is a defined distance that allows the aggregate beams to combine with each other to allow beam steering to be performed. The steered beam is used to convey (i.e., transmit and/or receive) user information. User information is information generated by mobiles and/or users of the communication system.

In one embodiment, the antenna phased array comprises four antennas forming two overlapping sub-arrays of three antennas each of which generates an aggregate beam having a beam width of 65° where both aggregate beams can be combined to perform beam steering. A two-input, four-output beam forming network is coupled to the four antennas and the signals from which the aggregate beams are formed are applied to the two inputs of the beam forming network. Adjacent antennas of the four antennas are placed

$$\frac{1}{2}$$

wavelength apart where the wavelength is related to a range of frequency values of the input signals. Thus, when the intelligent antenna network is mounted on a tower of a wireless communication system, two cables can be used to apply the signals to the beam forming network portion of the intelligent antenna network of the present invention.

Referring to FIG. 2 there is shown a block diagram of the antenna phased array of the present invention in which a 2-input, 4-output beam forming network 200 is coupled to matching network 202 which is coupled to antennas 204, 206, 208 and 210. Antennas 204-210 form an array of antennas. Each of the antennas can itself be an array of two or more antenna elements. Matching network 202 is circuitry that matches the impedance of the beam forming network to the impedance of the antennas. In a typical application, matching network 202 is an integral part of the antennas; that is, each of the antennas has a portion which serves as a matching circuit to beam forming network 200. Also, each of the antennas may be one antenna or an array of a multiple of antennas. Beam forming network 200 is interconnected such that antennas 204, 206 and 208 form one sub-array, viz., sub-array 1 and antennas 206, 208 and 210 form another sub-array, viz., sub-array 2. A signal applied to input 1 of beam forming network 200 is routed to outputs 1, 2 and 3 of beam forming network 200 thus activating antennas 204, 206 and 208. Thus, input 1 of beam forming network 200 is coupled to antennas 204, 206 and 208 via internal circuitry of beam forming network 200. A signal applied to input 2 of beam forming network 200 is routed to outputs 2, 3 and 4 of beam forming network 200 thus activating antennas 206, 208 and 210. Input 2 of beam forming network 200 is thus coupled to antennas 206, 208 and 210 via internal circuitry of beam forming network 200. Note that antennas 206 and 208 are part of both sub-arrays. Thus, the sub-arrays are said to be overlapping. Overlapping sub-arrays are two or more sub-arrays having at least one common antenna or antenna element. The signals applied to the inputs of beam forming network 200 have a range of frequencies. A wavelength of such signals is obtained by taking an average or mean of all of the wavelengths of that signals. It is well known that a signal of frequency ƒ, has a wavelength λ where

$$f = \frac{c}{λ}$$

and where c is a well known constant representing the speed of light in a vacuum. Adjacent antennas may be spaced a distance of

$$\frac{λ}{2}$$

apart. Each of the antennas generate a signal beam from signals applied to inputs 1 and 2 of beam forming network 200. The beam forming network 200 interconnects the antennas such that the signals radiated from the antennas in sub-array 1 (i.e., antennas 204, 206 and 208) combine with each other to form an aggregate beam of desired beam width. For example the aggregate beam from sub-array 1 may have a beam width of 65°. Similarly, signals radiated from the antennas of sub-array 2 also form an aggregate beam having a desired beam width; one desired beam width may be 65°. Further, beam forming network 200 can manipulate the aggregate beams so that they combine into one beam that can be steered thus allowing the intelligent antenna phased array of the present invention to perform beam steering.

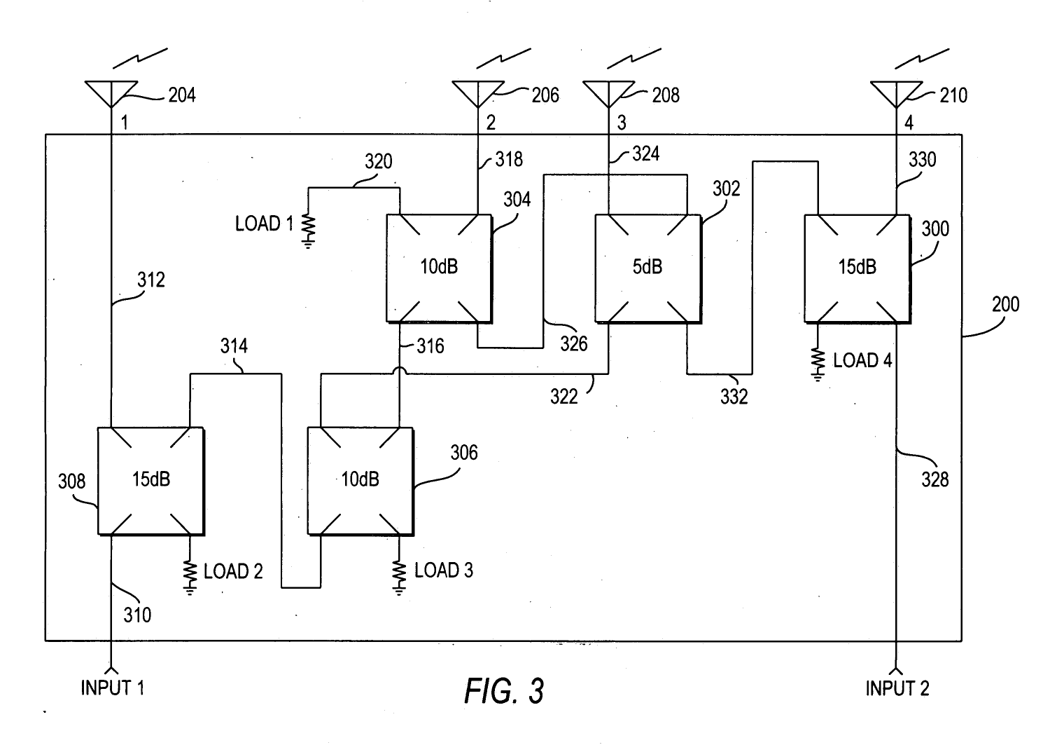

Referring now to FIG. 3 there is shown the antenna phased array of the present invention in which a specific implementation of beam forming network 200 is used. Note that matching network 202 is not shown in FIG. 3, because as previously explained, the matching networks for the antennas are an integral part of the antennas and thus are represented by the antennas. Beam forming network comprises five (5) interconnected hybrid couplers that couple the inputs of beam forming network 200 to its outputs which are directly coupled to the antennas 204-210. Hybrid couplers are passive devices or circuits that split the signal applied to the input to two outputs in a certain ratio with the phase difference between signals at the outputs equal to 90°. Hybrid couplers have at least one input and at least two outputs or ports. One output is a direct output or port which is electrically connected to the input. The other output is electromagnetically coupled to the input; such an output is referred to as a coupled port. Thus, a signal of a certain amplitude that is applied to an input of a hybrid coupler will appear at the coupled port or output of the hybrid coupler attenuated by the desired amount. The rest of the signal will appear at the direct port. The phase difference between the signals at the direct and coupled ports is 90°. The coupling (i.e., ratio of coupled output signal and input signal) experienced by a signal applied to the hybrid couplers of beam forming network is shown for each hybrid coupler. In particular, hybrid couplers 300 and 308 each has a coupling of 15 dB, hybrid couplers 306 and 304 each has an coupling of 10 dB and hybrid coupler 302 has an coupling of 5 dB. There are loads that are coupled to some of the outputs of the hybrid couplers. These loads (i.e., LOAD 1, LOAD 2, LOAD 3 and LOAD 4) are impedance devices or networks which may comprise resistors, capacitors, inductors and/or any other well known impedance component; typically, they are resistive 50 Ohm loads.

The hybrid couplers of beam forming network 200 are interconnected in the manner shown by paths which may be conductive paths and which act as distributed circuits depending on the frequency components of the input signals. The paths may also be circuits made from active and/or passive components. Regardless of the structure of the paths, they directly affect the relative phase of propagating signals. Thus, the paths can be referred to as phase shifters or phase shifting circuits because of their effect on the relative phase of signals that propagate through them.

Input 1 of beam forming network 200 is coupled to antenna 204 via hybrid coupler 308. Specifically, Input 1 is applied to path 310 which is applied to one input of hybrid coupler 308. The other input of hybrid coupler 308 is coupled to LOAD 2. One output of hybrid coupler 308 is applied to antenna 204 via path 312 and output 1 of beam forming network 200. The other output of hybrid coupler 308 is applied to an input of hybrid coupler 306 via path 314. LOAD 3 is applied to the other input of hybrid coupler 306. One output of hybrid coupler 306 is applied to an input of hybrid coupler 304 via path 316. The other output of hybrid coupler 306 is applied to an input of hybrid coupler 302 via path 322. One output of hybrid coupler 304 is coupled to antenna 206 via path 318 and output 2; the other output of hybrid coupler 304 is coupled to LOAD 1 via path 320. One output of hybrid coupler 302 is applied to antenna 208 via path 324 and output 3. The other output of hybrid coupler 302 is applied to an input of hybrid coupler 304 via path 326. Therefore, input 1 of beam forming network 200 is coupled to antenna 204 via hybrid coupler 308 and coupled to antenna 206 via hybrid couplers 308, 306 and 304 and further coupled to antenna 208 via hybrid couplers 308, 306 and 302.

Input 2 is applied to one input of hybrid coupler 300 via path 328. LOAD 4 is applied to the other input of hybrid coupler 300. One output of hybrid coupler 300 is coupled to antenna 210 via path 330 and output 4 of beam forming network 200. The other output of hybrid coupler 300 is applied to an input of hybrid coupler 302 via path 332. A review of the aforementioned connections and the diagram of FIG. 3 clearly show that Input 2 of beam forming network 200 is coupled to antenna 210 via hybrid coupler 300, antenna 208 via hybrid couplers 300 and 302 and antenna 206 via hybrid couplers 300, 302 and 304.

For a CDMA communication system in which the communication signals typically are in the frequency range of 824 MHz-896 Mhz or 1850 MHz-1990 MHz, from which a certain average wavelength is calculated, sub-array 1 (i.e., antennas 204, 206 and 208) generates an aggregate beam having a beam width of 65° and sub-array 2 (i.e., antennas 206, 208 and 210) also generates a beam having a beam width of 65° where adjacent antennas are placed half a wavelength apart. The intelligent antenna network of the present invention can also be applied to an UMTS.

We claim:

1. An antenna phased array comprising:
a beam forming network; and
a plurality of antennas coupled to the beam forming network and forming overlapping sub-arrays of antennas that generate beams from one or more signals applied to the beam forming network where the generated beams combine into aggregate beams having desired beam widths.

2. The antenna phased array of claim 1 where the antennas are arrays of two or more antenna elements.

3. The antenna phased array of claim 1 where a defined distance between adjacent antennas is such that it allows beam steering to be performed from a combination of the aggregate beams.

4. The antenna phased array of claim 1 where a defined distance between adjacent antennas is substantially equal to half a wavelength of the applied signals.

5. The antenna phased array of claim 1 where the beam forming network comprises a plurality of hybrid couplers interconnected with paths so as to affect phase and amplitude values of the applied signals.

6. The antenna phased array of claim 1 where the beam forming network has two inputs and four outputs.

7. The antenna phased array of claim 6 where each of the four outputs of the beam forming network is coupled to one of four antennas and where the antennas from two overlapping sub-arrays each of which generates an aggregate beam having a width of 65°.

8. The antenna phased array of claim 1 where one aggregate beam is used to broadcast information in a wireless communication system and at least two aggregate beams are combined to perform beam steering and to convey user information.

9. The antenna phased array of claim 8 where the wireless communication system is a CDMA system.

10. The antenna phased array of claim 8 where the wireless communication system is a UMTS.
